(19) United States
(12) Patent Application Publication
(10) Pub. No.: US 2007/0203811 A1
(43) Pub. Date: Aug. 30, 2007

(54) Method of auditing inventory

(76) Inventors: John M. Hoopes, Washington, IL (US); Pauline C. Agbodjan-Prince, Peoria, IL (US); Douglas C. Meyer, Morton, IL (US); Zhiming Qu, East Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/363,092

(22) Filed: Feb. 28, 2006

(51) Int. Cl. G06Q 10/00

(52) U.S. Cl. 705/28

(57) ABSTRACT

A method of auditing inventory. The method includes determining a first check as a function of an identifying tag. The first check is configured to identify at least one first condition. The identifying tag is indicative of at least one of a rating, a ranking within a hierarchical scale, a grade, or a type of product. The method also includes electronically communicating first data to a first user. The first data is indicative of the first check and includes at least one command configured to solicit second data from the first user. The method also includes establishing second data indicative of at least one second condition, as a function of the at least one command. The method further includes electronically communicating the second data to a second user and automatically comparing the second data with third data, the third data indicative of at least one third condition.

### TECHNICAL FIELD

The present disclosure relates to a method of auditing and, more particularly, to a method of auditing inventory.

### BACKGROUND

Products, e.g., parts, components, and/or supplies, are typically stored within one or more facilities, e.g., a warehouse, a silo, a store room, a bin, a shelf, and/or any other suitable type of facility known in the art. Usually, inventory records regarding one or more attributes, e.g., type, quantity, or location, of the products are maintained and such records are usually compiled from delivery receipts, bills of lading, purchase orders, purchase receipts, and/or any other suitable procurement documents. Often, discrepancies exist between the records and the actual inventory of products stored within the facility and inventory audits are periodically conducted to reconcile the inventory records and the stored products. An inventory audit usually includes one or more individuals physically counting the actual products within the facility and manually comparing the counted products with the inventory records. Physical counting and manual comparisons require significant investment in time and personnel, are prone to errors, are typically expensive, and are often inaccurate.

U.S. Pat. No. 6,325,283 (“the '283 patent”) issued to Chu et al. discloses a computer implemented program for inventory management. Specifically, the '283 patent discloses a system which allows a user, unskilled in database or programming procedures, to access a database, create a scanner program for use with a scanning device, and update the existing database with data collected via the scanning device. The user accesses a graphical user interface (“GUI”), selects data that the user desires to collect and/or verify, and the GUI builds a format file and data set which is transferred to the scanning device. The scanning device prompts the user to enter data and, in response, the user scans or keys data into the scanning device. After the user completes entering data into the scanner, the data is transferred from the scanning device to the GUI and the GUI archives and updates the database with respect to the entered data.

Although the system of the '283 patent may enable a user to transfer data from a database in a GUI to a scanning device, obtain new data with the scanning device, and transfer the new data to the GUI, the user must have specialized knowledge or experience to determine the type and amount of new data to collect. Simply, the system of the '283 patent merely enables a user to perform a manual inventory check with a scanning device and transfer data between the scanning device and a remote database. Additionally, the GUI of the '283 patent may amend the database with scanned data when such an amendment may be inappropriate and/or undesirable, such as, for example, when a user incorrectly obtains data via the scanning device.

The present disclosure is directed to overcoming one or more of the shortcomings set forth above.

### SUMMARY OF THE INVENTION

In one aspect, the present disclosure is directed to a method for auditing inventory. The method includes determining a first check as a function of an identifying tag. The first check is configured to identify at least one first condition. The identifying tag is indicative of at least one of a rating, a ranking within a hierarchical scale, a grade, or a type of product. The method also includes electronically communicating first data to a first user. The first data is indicative of the first check and includes at least one command configured to solicit second data from the first user. The method also includes establishing second data indicative of at least one second condition, as a function of the at least one command. The method further includes electronically communicating the second data to a second user and automatically comparing the second data with third data, the third data indicative of at least one third condition.

In another aspect, the present disclosure is directed to a work environment for auditing an inventory including a plurality of products. The work environment includes at least one computer, at least one interface device including at least one microprocessor and at least one memory, and at least one electronic database including first data indicative of the plurality of products. The work environment also includes a program configured to receive at least one input from the at least one computer and the at least one interface device. The program is also configured to access the at least one database as a function of either of the received inputs and automatically perform at least one algorithm to establish a first check. The first check is configured to identify at least one of a product location, product type, or product quantity, associated with a subset of the plurality of products. The program is also configured to electronically communicate second data to a first user via the at least one interface device. The second data is indicative of at least one command and configured to instruct the first user to perform the first check to establish third data. The program is also configured to electronically receive the third data from the at least one interface device and automatically compare at least a portion of the first data with the third data.

In yet another aspect, the present disclosure is directed to a method of auditing an inventory of a plurality of products stored within a facility. The method includes establishing a database with first data indicative of predetermined inventory information and determining an inventory check as a function of a predetermined type of facility or a predetermined type of product associated with the plurality of products. The inventory check is configured to audit a first subset of the plurality of products and the first subset is configured as a statistical representation of the plurality of products. The method also includes electronically communicating second data indicative of the determined inventory check to a first user and performing the inventory check to identify and scan indicia representative of a location within the facility operatively associated with the first subset. The method also includes electronically communicating third data indicative of the location operatively associated with the first subset and automatically comparing the third data with the first data to determine if the third data substantially matches a respective subset of the first data. The method further includes communicating fourth data to a third user, the fourth data indicative of the compared third and first data.

### BRIEF DESCRIPTION OF THE DRAWINGS

FIG. 1 is a flow chart of an exemplary method for auditing inventory in accordance with the present disclosure; and

FIG. 2 is a schematic illustration of an exemplary work environment for performing the method of FIG. 1.

### DETAILED DESCRIPTION

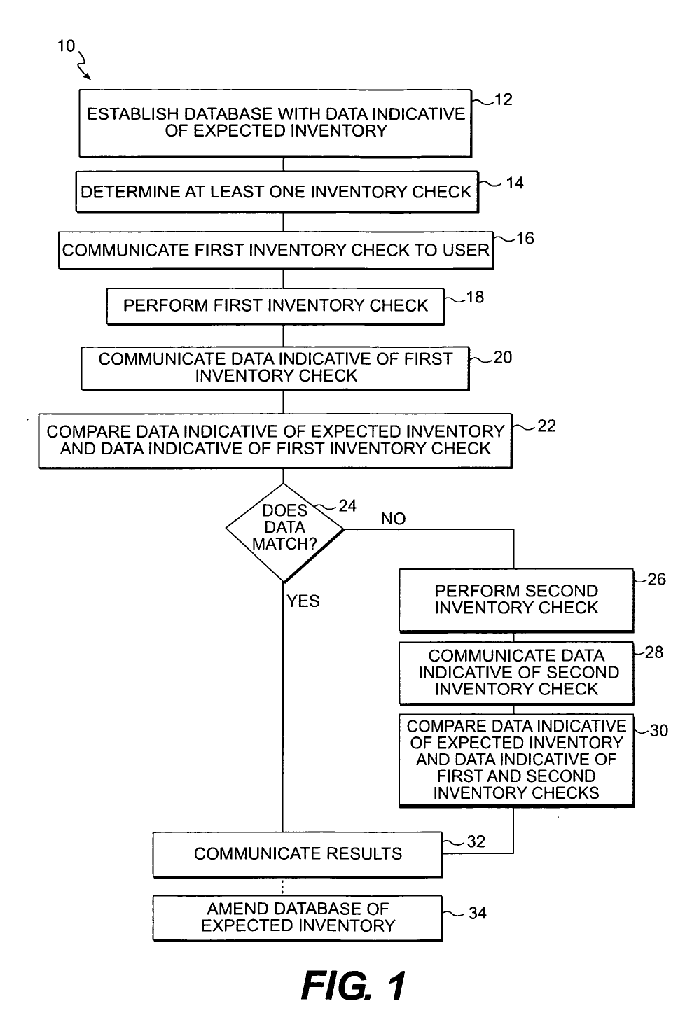

FIG. 1 illustrates an exemplary method 10 for auditing inventory. Method 10 may include establishing a database with data indicative of expected inventory, step 12. Method 10 may also include determining a first inventory check, step 14, and communicating the first inventory check to a user, step 16. Method 10 may also include performing the first inventory check, step 18, and communicating data indicative of the first inventory check, step 20. Method 10 may also include comparing the data indicative of the expected inventory and the data indicative of the first inventory check, step 22. Method 10 may also include determining whether the data match, step 24 and, if not, method 10 may include performing a second inventory check, step 26, and communicating data indicative of the second inventory check, step 28. Method 10 may also include comparing the data indicative of the expected inventory and the data indicative of the first and second inventory checks, step 30. If the data do match, method 10 may include communicating results, step 32 and may further include amending the database of expected inventory, step 34. Method 10 may also include performing step 30 after comparing data indicative of the expected inventory and data indicative of the first and second inventory checks, step 28. It is contemplated that the steps associated with method 10 may be performed in any order and are described herein in a particular sequence for exemplary purposes only. It is also contemplated that method 10 may be performed continuously, periodically, singularly, as a batch method, and/or may be repeated as desired.

Step 12 may include compiling a database with data indicative of expected inventory. Specifically, step 12 may include populating a database with data indicative of information from one or more documents associated with procuring and storing products, such as, for example, purchase orders, invoices, delivery receipts, bills of lading, and/or any other type of document. The compiled data may be configured as an inventory record of products expected and/or predicted to be stored within an inventory facility, e.g., a warehouse, a store room, a bin, a container, a drawer, a shelf, a defined un-walled location, any suitable location for housing and/or positioning one or more products as is known in the art, and/or any combination thereof. It is contemplated that a user may populate the database via any suitable method, such as, for example, data entry via a keyboard with reference to hardcopy paper documents or executing an algorithm configured to automatically populate the database with reference to electronic virtual documents stored within one or more databases and/or memory devices. It is also contemplated that compiling the database may include receiving a previously compiled database from a user, e.g., a warehouse manager or a customer, via an electronic mail or a file transfer protocol.

Step 14 may include determining at least one inventory check. Specifically, step 14 may include determining a subset of products stored within the inventory facility as a function of an identifier, e.g., a grade, a rank, a type of part stored within the facility, and/or any other identifier based on any suitable criteria known in the art. Further details of an identifier are described below with reference to step 22. For example, step 14 may include determining a subset of products because the subset of products is representative of a high volume type of product, e.g., a product of which the inventory facility frequently receives and ships large quantities. Additionally, step 14 may include determining a subset of products because a previous audit of similar products established a large discrepancy between the predicted inventory and the actual inventory. Furthermore, step 14 may include determining a subset of products because the subset represents a statistical percentage of total products. It is contemplated that step 14 may include determining an inventory check for a particular shelf and particular type of product as a statistical sampling of additional products of the same type located elsewhere within the inventory facility. As such, some of the stored product may be checked to establish a relatively high statistical confidence with respect to all of the stored product. It is also contemplated that step 14 may be automatically performed as a function of inputs into one or more algorithms.

Step 16 may include communicating the first inventory check to a user. Specifically, step 16 may include electronically communicating data indicative of the determined inventory check to a user to notify and command the user to perform the determined inventory check. For example, step 16 may include sending an electronic transmission, e.g., a file transfer protocol, to the user via a wired or wireless connection via, for example, an infrared or radio link, a local area network, an input/output cable directly connected between an interface device and a computer, the Internet, and/or any other suitable electronic transmission. It is contemplated that the electronically communicated data may be configured as inputs to one or more algorithms which, when performed, communicate, e.g., display, a series of commands to a user. It is also contemplated that the series of commands may be configured to instruct the user to perform the first inventory check. It is further contemplated that an inventory check may include determining an inventory location, a product type, a product quantity, and/or any one or more thereof.

Step 18 may include performing the first inventory check. Specifically, step 18 may include a user substantially following the commands communicated during step 16. For example, a user may, as a function of a first command, identify a location within the inventory facility and become positioned adjacent the first location. The user may, via an algorithm, e.g., a program, or a device, e.g., a microprocessor, obtain and communicate data indicative of the first location. For example, the user may scan a barcode or other indicia associated with a particular bin to identify the bin as the first location. The one or more algorithms may verify that data indicative of the obtained indicia substantially matches data indicative of the determined first location. It is contemplated that an interface device, e.g., a barcode scanner, may display that the obtained location and the determined location substantially match or do not substantially match via any suitable mechanism, such as, for example, an audio display, e.g., a series of beeps, a visual display, e.g., text or graphics, a physical display, e.g., vibration, any other type of display known in the art, and/or a combination thereof. It is also contemplated that the user may identify and scan any number of locations in response to any number of commands.

Additionally, step 18 may, for example, include a user identifying a type and/or quantity of products operatively associated with the identified location, as a function of a second command. The user may via an algorithm, e.g., a program, or a device, e.g., a microprocessor, obtain and communicate data indicative of the type and/or quantity of products. For example, the user may scan a barcode or other indicia associated with one or more products or groups of products to identify such products. It is contemplated that the barcode of one or more products or groups of products may represent data regarding the type of product, e.g., a product description, and/or a quantity of products associated with the barcode, e.g., quantity of products within a box of products. It is also contemplated that the user may identify and obtain data indicative of any number of types and/or quantities of products. It is further contemplated that the user interface device may obtain and/or store the data indicative of the location, type, and/or quantity of products in any suitable method known in the art, such as, for example, scanning or receiving infrared, radio, and/or global positioning signals.

Step 20 may include communicating data indicative of the first inventory check. Specifically, step 20 may include an interface device communicating data indicative of the performed first inventory check to an algorithm, e.g., a program, or a device, e.g., a microprocessor, configured to evaluate the data. For example, the interface device may communicate the data via a file transfer protocol, an electronic mail communication, via a hardwired or wireless connection, and/or any other suitable method for transferring data known in the art, to a central server, a computer on which a program is stored, and/or a computer for temporary data storage. It is contemplated that the interface device may communicate the data as a function of an executed command and/or algorithm, e.g., via a virtual object orientated computer command and/or other mechanisms known in the art, e.g., a button or a trigger.

Step 22 may include comparing data indicative of expected inventory and data indicative of the first inventory check. Specifically, step 22 may include performing one or more algorithms configured to compare data and determine if respective data substantially match. For example, the data indicative of the expected inventory, e.g., the data compiled from purchase orders, and/or a subset thereof may be compared to respective data indicative of the first inventory check, e.g., the location, type, and/or quantity of products obtained from scanned barcodes. It is contemplated that one or more results from the comparison of respective data may be temporarily or permanently stored within an electronic memory, may be indicative of whether the respective data substantially match, and/or indicative of other data, e.g., percentages, of the compared data. It is also contemplated that step 22 may be automatically performed via one or more algorithms as a function of the data indicative of the first inventory check. It is contemplated that step 22 may include any suitable algorithm configured to compare data known in the art, such as, for example, an algorithm that sequentially matches one or more bytes of first data with respective one or more bytes of second data. It is further contemplated that step 22 may include associating an identifying tag of an inventory facility as a function of the compared data. For example, the identifying tag may include a “passing” or “failing” grade as a function of an allowable discrepancy threshold, a hierarchal ranking as a function of other audited inventory facilities or a predetermined ranking based on particular discrepancy criteria or thresholds, and/or any other type of rating known in the art.

Step 24 may include determining if the data match. Specifically, step 24 may establish if the data indicative of the expected inventory substantially matches the data indicative of the first inventory check. If the data indicative of the first inventory check substantially matches the data indicative of the expected inventory, method 10 may perform step 32, and if not, method 10 may perform step 26. It is contemplated that step 24 may include an algorithm configured to identify one or more results established during step 22 to determine whether or not the data match.

Steps 26 and 28 may be substantially similar to steps 18 and 20. As such, a detailed description thereof is omitted for clarification purposes. It is contemplated that the second inventory check may be substantially the same as the first inventory check and, accordingly, steps 26 and 28 may be configured to substantially repeat the first inventory check to confirm or verify the data indicative of the location, type, and/or quantity of products obtained during steps 18 and 20. It is also contemplated that the second inventory check may, alternatively, be different from the first inventory check and may obtain new data, e.g., a larger subset to improve statistical extrapolation.

Step 30 may be substantially similar to step 22 and, as such, a detailed description thereof is omitted for clarification purposes. It is contemplated that one or more results from the comparison of respective data may be temporarily or permanently stored within a memory and/or may be indicative of one or more respective data that do or do not substantially match. It is also contemplated that step 30 may be automatically performed via one or more algorithms as a function of the data indicative of the first and second inventory checks. It is further contemplated that if the data indicative of the first inventory check does not substantially match the data indicative of the second inventory check, method 10 may include determining and performing one or more subsequent inventory checks, as desired.

Step 32 may include communicating the results. Specifically, step 32 may include electronically communicating, e.g., via an electronic mail or a file transfer protocol, data indicative of the comparison performed during step 30 to a user. For example, step 32 may include sending an electronic mail to an inventory facility manager and notifying the manager of the data indicative of the first and second inventory checks, e.g., that the data indicative of the first and second inventory checks do not substantially match the data indicative of the expected inventory. It is contemplated that if the results indicate that the expected inventory substantially matches one or both of the first and second inventory checks, method 10 may stop after performing step 32. It is also contemplated that if the results indicate that the expected inventory does not substantially match one or both of the first and second inventory checks, method 10 may perform step 34. It is contemplated that step 32 may also include communicating the identifying tag to the user, e.g., a warehouse manager or other suitable customer. It is also contemplated that the user may during step 32, evaluate the results and, for example, consider a percentage discrepancy between the expected inventory and an inventory check to be indicative of all the expected inventory, consider a discrepancy between the expected inventory and an inventory check to be acceptable, and/or may evaluate the results according to any suitable criteria.

Step 34 may include amending the database of expected inventory. Specifically, step 34 may include adding and/or changing data populated within the compiled database to match the data indicative of the first and/or second inventory checks if the data indicative of the expected inventory is different than the data indicative of the first and second inventory checks. For example, if the first and second inventory checks determine a first quantity of products are associated within a particular inventory facility and the expected inventory includes a second quantity of products expected to be associated within the particular inventory facility, the data indicative of the quantity within the expected inventory may be changed to substantially match the data indicative of the quantity determined during the first and second inventory checks. It is contemplated that the data indicative of the expected inventory may be amended via any suitable method known in the art, such as, for example, an algorithm or manual data entry. It is also contemplated that step 34 may include displaying data indicative of the amendments made to the expected inventory. If is further contemplated that step 34 may include reallocating products from one location to another, may change the title or description of products and/or locations, and/or may adjust the data indicative of the expected inventory by any suitable criteria, as desired.

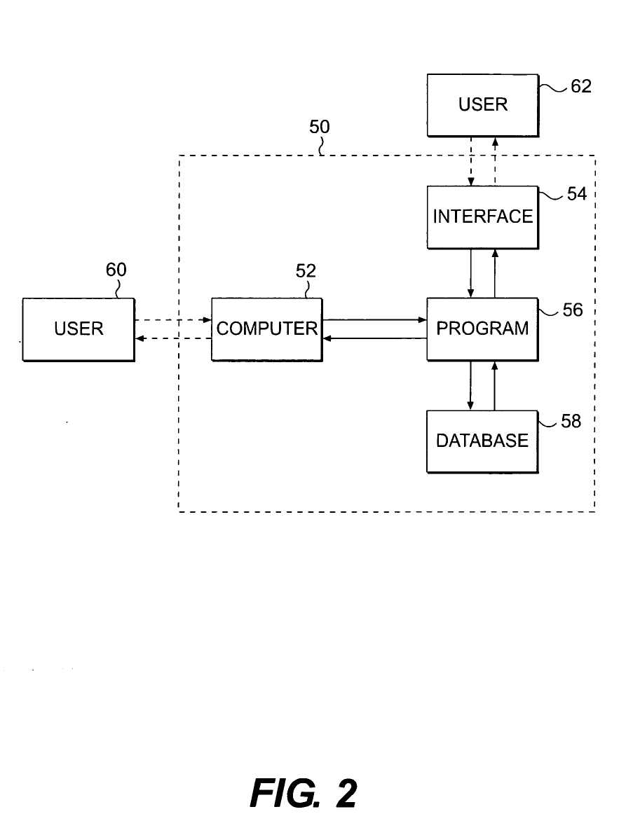

FIG. 2 illustrates an exemplary work environment 50 for performing method 10. Work environment 50 may include at least one computer 52, an interface 54, a program 56, and at least one database 58. Work environment 50 may be configured to accept inputs from one or more users 60, 62 via computer 52 and interface 54. Work environment 50 may be further configured to communicate and/or display data to users 60, 62 via computer 52 and interface 54. It is contemplated that work environment 50 may include additional components such as, for example, a communications interface (not shown), a memory (not shown), central or remote servers (not shown), and/or other components known in the art.

Computer 52 may include a general purpose computer, e.g., a desktop or a laptop computer, configured to operate executable computer code. Computer 52 may include one or more input devices, e.g., a keyboard (not shown) or a mouse (not shown), to introduce inputs from users 60, 62 into work environment 50 and may include one or more output devices, e.g., a monitor, to deliver outputs from work environment 50 to user 60. Specifically, user 60 may communicate one or more inputs, e.g., data, into work environment 50 via computer 52 to supply data to and/or execute program 56. Computer 52 may also include one or more data manipulation devices, e.g., data storage or software programs (not shown), to transfer and/or alter user inputs. Computer 52 may also include one or more communication devices, e.g., a modem (not shown) or a network link (not shown), to communicate inputs and/or outputs with program 56. It is contemplated that computer 52 may further include additional and/or different components, such as, for example, a memory (not shown), a communications hub (not shown), a data storage (not shown), a printer (not shown), an audio-video device (not shown), removable data storage devices (not shown), and/or other components known in the art. It is also contemplated that computer 52 may communicate with program 56 via, for example, a local area network (“LAN”), a hardwired connection, and/or the Internet. It is further contemplated that work environment 50 may include any number of computers, e.g., a plurality of computers, and that each computer associated with work environment 50 may be accessible by any number of users for inputting data into work environment 50 and communicating data with program 56.

Interface 54 may include a microprocessor configured to operate computer executable code, to interpret indicia, display data to a user, and/or communicate with program 56. Specifically, interface 54 may be configured to perform one or more algorithms and may additionally include a memory, an indicia scanning apparatus, a display, communication ports, and/or other components known in the art. For example, interface 54 may include a barcode scanner, an infrared scanner, an optical scanner, an ultraviolet scanner, a global positioning device, a radio transmitter, and/or other suitable device configured to interpret any type of indicia such as, for example, textual, numerical, symbolic, graphical, electrical, optical, and/or any other type of indicia known in the art. Interface 54 may also be configured to produce audio, e.g., beeps, visual, e.g., flashing lights, and/or physical, e.g., vibrations, to communicate with and/or provide warnings to a user. It is contemplated that interface 54 may include one or more interface mechanisms, e.g., a key pad, one or more buttons, a touch screen, and/or any other user interface mechanism known in the art. It is also contemplated that interface 54 may interact with program 56 and/or other components of work environment 50, for example, wirelessly, via the Internet, or via a LAN, and interface 54 may or may not be a mobile apparatus such as, for example, a handheld scanner, a personal data assistant, cellular telephone, and/or any other portable apparatus.

Program 56 may include a computer executable code routine configured to perform one or more sub-routines and/or algorithms to evaluate and/or manipulate data within work environment 50. Specifically, program 56 may be configured to perform one or more steps of method 10. Program 56 may receive inputs, e.g., data, from either or both of computer 52 and/or interface 54, perform one or more algorithms to manipulate the received data, deliver one or more outputs, e.g., algorithmic results, and/or communicate, e.g., send electronic mail, to users 60, 62 via computer 52 and/or interface 54. Program 56 may also access database 58 to locate and manipulate data stored therein to arrange and/or display stored data to one or more of users 60, 62 via computer 52 or interface 54, e.g., via an interactive object oriented screen display. It is contemplated that program 56 may be stored within the memory (not shown) of computer 52 and/or stored on a remote server (not shown) accessible by computer 52 and/or interface 54. It is also contemplated that program 56 may include additional sub-routines and/or algorithms to perform various other operations with respect to mathematically representing data, generating or importing additional data into program 56, and/or performing other computer executable operations. It is further contemplated that program 56 may include any type of computer executable code, e.g., C++, and/or may be configured to operate on any type of computer software platform, e.g., IBM's Lotus® software.

Database 58 may be configured to store and arrange data and to interact with program 56. Specifically, database 58 may be configured to store and arrange data indicative of the expected inventory compiled during step 12 (referring to FIG. 1). Database 58 may store and arrange any quantity of data in any suitable or desired format and program 56 may be configured to access database 58 to identify particular data therein and display such data to one or more of users 60, 62. For example, user 60 may access database 58, via program 56, to identify data stored therein indicative of a location, type, or quantity of a product expected to be located within the inventory. It is contemplated that database 58 may include any suitable type of database such as, for example, a spreadsheet, a two dimensional table, or a three dimensional table, and may arrange and/or store data in any manner known in the art, such as, for example, within a hierarchy, in groupings according to associated criteria, and/or searchable according to associated identifying tags. It is also contemplated that database 58 may store any kind of additional data directly associated with the one or more products, e.g., product description, product purchase order number, and/or may store any kind of additional data indirectly associated with the one or more products, e.g., date of last inventory audit.

Users 60, 62 may include any entity configured to interact with work environment 50. For example, users 60, 62 may include a system manager configured manage an inventory, personnel associated with a system for procuring products, e.g., purchasers, warehousemen, clerks, general personnel, and/or any other entity associated with the inventory of products. For example, user 60 may populate database 58 with data indicative of product location, type, and/or quantity and may perform, in conjunction with program 56, one or more of steps 12, 14, 16, 22, 30, 32, and 34 and user 62 may perform one or more inventory checks and may, in conjunction with program 56, perform one or more of steps 18, 20, 26, and 28. It is contemplated that users 60, 62 may or may not be the same entity and that each of users 60, 62 may include a plurality of entities.

### INDUSTRIAL APPLICABILITY

The disclosed system may be applicable for auditing any inventory. The disclosed method and apparatus may increase the accuracy of obtaining data indicative of products within an inventory facility and may provide a less complicated method for verifying and, if desired, amending data indicative of expected inventory. The operation of method 10 is explained below with reference to an exemplary inventory audit of a warehouse and it is noted that method 10 may be applicable to any inventory facility.

A warehouse may store a plurality of products within one or more bays, racks, bins, and/or other product storage locations or apparatus. For example, the warehouse may store a first type of parts, e.g., first parts, in one or more first bays designated as “Bin 1-A, Bin 1-B, . . . Bin 1-Nth” and may store a second type of part, e.g., second parts, in one or more second bays designated as “Bin 2-A, 2-B, . . . 2-Nth.” An expected inventory for the first type of part may be determined to be 1000 parts because a purchase order was generated and a warehouse receipt confirms that 1000 first parts were ordered and delivered to the warehouse. Similarly, an expected inventory for the second type of part may be determined to be 2000 parts. It is contemplated that the warehouse may include any quantity of bays and/or other product storage locations and may include any quantity or type of products, as desired.

Confidence in the actual number of first and second parts stored within the warehouse may be less than 100% because of, for example, expectation of human error in shipping and/or receiving, product damage occurring during delivery of products to and/or movement of products within the warehouse, results from previous inventory audits and/or any other criteria known in the art. Accordingly, an entity, e.g., a warehouse manager, may desire an accurate inventory assessment, e.g., may desire a substantially exact quantity of first and second products that may be actually stored within the warehouse. It is contemplated that any suitable criteria may influence the desire for accurately determining substantially exact quantities of products, such as, for example, downstream manufacturing processes, customers, purchasing control, reducing overhead expenses, reducing operating expenses due to missing products, and/or any other criteria known in the art.

Accordingly and with reference to FIGS. 1 and 2, method 10 (see FIG. 1) may be performed to audit the first and second parts stored within the warehouse. For example, a first user, e.g., user 60, may access work environment 50 via computer 52 and may access one or more algorithms, e.g., program 54, and/or a compiled database of expected inventory, e.g., database 58 (see FIG. 2). User 60, via one or more inputs communicated to computer 52 and program 56, may determine one or more inventory checks, e.g., a first inventory check, to establish statistical verification of the expected inventory (step 14). That is, the first inventory check may be determined by commanding program 56 to perform one or more algorithms to develop predetermined and/or random inventory checks as a function of an inventory identifying tag. It is contemplated that such inventory checks may be determined for subsets of the first and second parts which may be extrapolated to be indicative of all of the stored first and second parts.

The first and second inventory checks may be communicated to a second user, e.g., user 62 (step 16), and user 62 may perform the first inventory check (step 18). For example, program 56 may, via an electronic file transfer, communicate a series of commands to an interface 54, e.g., a barcode scanner. User 62 may, as a function of the communicated commands stored within the barcode scanner, follow the commands. For example, user 62 may, in response to interface 54 displaying a command to identify “Bin 1-A,” identify and report to a first inventory location, e.g., “Bin 1-A,” and scan a barcode identifying the first location. Similarly and in response to subsequent commands, user 62 may also identify one or more first parts, e.g., 90 first parts, associated with “Bin 1-A” and scan barcodes identifying the first parts. The inventory location and type and quantity of products may be stored as data within the barcode scanner and user 62 may identify additional products associated with the inventory location and/or identify additional inventory locations as a function of the commands of an inventory check. User 62 may communicate, via an electronic file transfer, the results of the first inventory check to program 56 and subsequently perform the second inventory check, if desired.

Program 56 may, as a function of the received results, e.g., data indicative of the first and/or second inventory checks, automatically compare the results with the expected inventory (steps 22, 30). User 60 and/or program 56 may communicate the results of the compared inventory checks and the expected inventory to the warehouse manager. For example, if the expected inventory for “Bin 1-A” was 100 first parts, the inventory facility may be identified with a “passing” grade because the predicted location of first parts was verified as accurate and the discrepancy between the predicted quantity and actual quantity of first parts was within an acceptable range. As such, method 10 may include communicating the determined quantity of first parts and the “passing” grade to the warehouse manager. Similarly, method 10 may include determining results for the audit of the second parts and communicate such results to the warehouse manager. It is contemplated that any discrepancy may be associated with any acceptable range or threshold.

The warehouse manager may, as a function of the communicated results, desire to amend the expected inventory of first parts to be 90 instead of 100 and may similarly amend the expected inventory of second parts. Alternatively, the warehouse manager may desire to conduct a more detailed audit of the first and second parts, e.g., repeat method 10 with respect to additional bins and/or reconcile the determined discrepancies via any suitable manner. It is contemplated that method 10 may be repeated at any frequency to audit inventory stored within an inventory facility.

Additionally, the warehouse may be disposed at a remote location and, as such, the database of expected inventory may be stored within a memory of computer 52. For example, if the warehouse is unconnected and/or inaccessible to program 56 and/or database 58, e.g., the warehouse is not connected to the Internet or a LAN through which work environment 50 may be interconnected. However, a warehouse manager may nonetheless desire an inventory audit. A database of the expected inventory of the remote warehouse, e.g., database 58, and program 56 may be stored within a memory of computer 52 which may embody a laptop, e.g., a mobile, computer. Accordingly, method 10, and in particular the electronic communicating within method 10, may be performed at or near the remote warehouse. For example, computer 52 and interface 54 may be directly hardwire connected to one another via an input/output cable.

Because method 10 may include electronic verification of inventory location, product type, and product quantity, the inventory audit may be more accurate than manual counting and hardcopy paper inventory verification. Method 10 and work environment 50 may reduce the quantity of hardcopy paper files and manual data entry of results of inventory checks and/or amendments to expected inventory compilations which may reduce unintentional errors associated with performing an inventory audit. Additionally, because method 10 may include automatically determining first and second inventory checks as a function of facility identifying tags, a user performing and/or establishing an inventory audit may not require specialized knowledge and/or experience to establish the checks. Also, because program 56 and database 58 may be stored on a laptop computer, e.g., computer 52, and interface 54 may embody mobile barcode scanners, method 10 may be performed at remote inventory facilities. As such, the unique difficulties associated with performing a manual inventory audit at a remote location, e.g., transportation of paper documents or numerous personnel and the potential loss of documents and expense of transportation, may be reduced. Furthermore, method 10 and work environment 50 may provide a less complex, more accurate, and faster system for auditing inventory.

It will be apparent to those skilled in the art that various modifications and variations can be made to the disclosed system for auditing inventory. Other embodiments will be apparent to those skilled in the art from consideration of the specification and practice of the disclosed method and apparatus. It is intended that the specification and examples be considered as exemplary only, with a true scope being indicated by the following claims and their equivalents

What is claimed is:

1. A method for auditing a facility storing at least one product comprising:
determining a first check as a function of an identifying tag, the first check being configured to identify at least one first condition and the identifying tag being indicative of at least one criteria;
electronically communicating first data to a first user, the first data indicative of the first check and including at least one command configured to solicit second data from the first user;
establishing second data indicative of the at least one second condition as a function of the at least one command;
electronically communicating the second data to a second user; and
automatically comparing the second data with third data, the third data indicative of at least one third condition.

2. The method of claim 1, further including:
automatically communicating fourth data indicative of the compared second and third data to a third user; and
amending the third data to substantially match the second data if the third data does not substantially match the second data.

3. The method of claim 1, wherein the at least one product is a plurality of products and the third data is predetermined and indicative of:
a predicted type and quantity of the plurality of products; and
a predicted location associated with the plurality of products.

4. The method of claim 1, further including determining the third data as a function of at least one of a purchase order, a shipping notice, a bill of lading, or a delivery receipt associated with procuring the at least one product from a supplier.

5. The method of claim 1, further including:
determining fourth data indicative of the compared second and third data; and
assigning the identifying tag to the facility as a function of the fourth data.

6. The method of claim 1, wherein establishing the second data includes scanning indicia operatively associated with at least one of a location of a facility, a type of a product, or a quantity of a product.

7. The method of claim 1, wherein electronically communicating the first or second data includes performing a file transfer protocol between a first microprocessor and a second microprocessor.

8. The method of claim 1, wherein the at least one first, second and third conditions each include at least one of a location within the facility, a type of product stored within the facility, or a quantity of product stored within the facility.

9. The method of claim 1, wherein the at least one criteria includes at least one of a rating, a ranking within a hierarchical scale, a grade, or a type of product.

10. A work environment for auditing an inventory of a plurality of products comprising:
at least one computer;
at least one interface device including at least one microprocessor and at least one memory;
at least one electronic database including first data indicative of the plurality of products; and
a program configured to:
receive at least one input from the at least one computer and the at least one interface device,
access the at least one database as a function of either of the received inputs,
automatically perform at least one algorithm in response to the received at least one input from the computer to establish a first check, the first check configured to identify at least one of a product location, product type, or product quantity, associated with a subset of the plurality of products,
electronically communicate second data to a first user via the at least one interface device, the second data indicative of at least one command and configured to instruct the first user to perform the first check to establish third data,
electronically receive the third data from the at least one interface device, and
automatically compare at least a portion of the first data with the third data.

11. The work environment of claim 10, wherein the at least one interface device includes at least one of a barcode scanner, an optical scanner, or an infrared scanner.

12. The work environment of claim 10, wherein:
the first data is indicative of at least a plurality of predetermined quantities respectively associated with the plurality of products;
the third data is indicative of at least a quantity respectively associated with a plurality of products stored within an inventory facility; and
comparing at least a portion of the first data includes determining if a predetermined quantity associated with a the first data substantially matches a quantity associated with a first plurality of products stored within the inventory facility.

13. The work environment of claim 12, wherein the program is further configured to communicate with the at least one computer and display data indicative of the comparison between the predetermined quantity associated with the first data and the quantity associated with the first plurality of products.

14. The work environment of claim 10, wherein the plurality of products are stored within at least one of a warehouse, a room, a bin, a bay, a container, or a predefined location.

15. The work environment of claim 10, wherein the program is further configured to electronically communicate data between the at least one interface and the at least one computer and communicating the second data includes communicating data indicative of at least one of a location within an inventory facility, a type of product associated with the plurality of products, or a quantity of products associated with the plurality of products.

16. The work environment of claim 10, wherein the at least one interface is configured to:
receive the second data;
display a first command to the first user, the first command configured to instruct the first user to input fourth data indicative of a first location within an inventory facility and receive the fourth data;
display a second command to the user, the second command configured to instruct the first user to input fifth data indicative of a type of product associated with the first location and receive the fifth data; and
display a third command to the user, the third command configured to instruct the first user to input sixth data indicative of a quantity of product associated with the first location and receive the sixth data.

17. The work environment of claim 10, wherein:
the at least one computer is a laptop computer including a computer memory;
the at least one electronic database and the program are stored within the computer memory;
the at least one computer is disposed adjacent a facility configured to store the plurality of products; and
the at least one interface device is directly connected to the at least one computer via an input/output cable when the program electronically communicates the second data.

18. A method of auditing an inventory of a plurality of products stored within a facility comprising:
establishing a database with first data indicative of predetermined inventory information;
determining an inventory check as a function of a predetermined type of facility or a predetermined type of product associated with the plurality of products, the inventory check configured to audit a first subset of the plurality of products, the first subset configured as a statistical representation of the plurality of products;
electronically communicating second data indicative of the determined inventory check to a first user;
performing the inventory check to identify and scan indicia representative of a location within the facility operatively associated with the first subset;
electronically communicating third data indicative of the location operatively associated with the first subset;
automatically comparing the third data with the first data to determine if the third data substantially matches a respective subset of the first data; and
communicating fourth data to a third user, the fourth data indicative of the compared third and first data.

19. The method of claim 18, wherein the inventory check is configured to identify a subgroup of the plurality of products, determine the accuracy of the at least a portion of the first data as a function of the third data, and statistically extrapolate the accuracy of the at least a portion of the first data to be representative of the accuracy of all of the first data.

20. The method of claim 18, wherein electronically communicating second and third data includes electronically communicating data between a computer and a barcode scanner.

21. The method of claim 20, wherein the inventory check is a first inventory check, the method further including:
determining a second inventory check as a function of a predetermined type of facility or a predetermined type of product associated with the plurality of products, the second inventory check configured to audit a second subset of the plurality of products, the second subset configured as a statistical representation of the plurality of products;
performing the second inventory check and electronically communicating fifth data indicative of the performed second inventory check;
comparing the at least a portion of the first data, third data, and fifth data; and
amending the first data to substantially match the third data if the third data substantially matches the fifth data and the third data does not substantially match the first data.

22. The method of claim 18, wherein:
the predetermined inventory information includes a plurality of product quantities, a plurality of product types, and a plurality of product locations within an inventory facility; and
establishing the database with first data includes populating the database with data indicative of the plurality of information and the plurality of information is indicative of information contained within at least one of a purchase order, a shipping notice, a delivery receipt, or an invoice.

23. The method of claim 18, wherein establishing the database includes receiving a database via an electronic mail from a customer requesting an inventory audit, the method further including:
establishing fourth data indicative of the compared third and first data; and
electronically communicating the fourth data to the customer; and
amending at least a portion of the respective subset of the first data as a function of an input from the customer.
